(19) United States
(12) Patent Application Publication
(10) Pub. No.: US 2024/0367086 A1
(43) Pub. Date: Nov. 7, 2024

(54) LOAD REDISTRIBUTION PACKAGING STRUCTURE

(71) Applicant: Pure Illusion, Inc., Research Triangle Park, NC (US)

(72) Inventor: James J. Moore, Durham, NC (US)

(21) Appl. No.: 18/653,389

(22) Filed: May 2, 2024

Related U.S. Application Data
(60) Provisional application No. 63/463,467, filed on May 2, 2023.

(51) Int. Cl. B01D 46/52; B65D 81/113

(52) U.S. Cl. CPC B01D 46/523; B65D 81/113; B01D 2265/06

(57) ABSTRACT

The present description provides for various embodiments for an external support structure that can be used to package and ship air filter frames. The support structure addresses a collapse problem that air filter frames may experience from an applied force to the top, bottom, or sides of an air filter frame during packaging and delivery. The support structure includes a top and bottom covers. The top cover includes a base component, a first and second end redistribution components, and one or more internal redistribution components. The bottom cover includes a base component and one or more internal redistribution components. The top and bottom covers are positioned around an air filter frame, to redistribute external forces applied to a top, a bottom, a left side, and a right side of the air filter frame. The forces are distributed evenly over the air filter frame and prevents collapse at pivot points.

This application is a non-provisional application which claims priority to U.S. Provisional Application No. 63/463,467 filed on May 2, 2023, which is incorporated by reference in its entirety.

### TECHNICAL FIELD

The present invention relates to a packaging product, and more particularly to a packaging product for air filter frames.

### BACKGROUND

Air purifier systems use filter technology, specifically air filters, to improve air quality by capturing most air pollutants. As a rule of thumb, it is recommended that air filters need to be changed out every 6 months to a year. This requires acquiring or purchasing replacement air filters, which people may purchase at a store or opt to purchase online. Either way, the air filters are packaged and shipped from a facility. At times, the air filters can be damaged or compromised during shipping because the packaging may not be able to support the air filter structure from any pressure being applied to the shipping packaging. For example, a box the air filters are shipped in may get stepped on or other items may be thrown on top of the air filter shipping box which may result in a damaged air filter frame leading to media bits leaking from the damage and/or poor air filtration due to damage.

There are certain filter frames that are much more susceptible to damage during shipping. For example, V-Cell air filter frames are inherently weak in comparison to the filtration media contained within the cells. This causes a very high collapse rate of the V-Cell filter frame at “pivot points.” These pivot points occur at the top of each V-Cell and at the adjacency point where V-Cells are bonded together. V-Cell air filter frames experience two types of collapse events: (1) End-Cell Collapse and (2) Accordion Collapse. An End-Cell Collapse is the most common structural damage that occurs in a V-Cell air filter frame. This is due to a single point at the bottom of the exposed End-Cell, which is subject to the load of the entire filter. This point acts as a lever upon a fulcrum at the top End-Cell “pivot point.” An Accordion Collapse occurs when a sufficient amount of force is applied to the End-Cell where a complete failure of the End-Cell does not dissipate the entire force placed on the V-Cell frame. When there is a residual load on the filter frame after an End-Cell collapse, a cascading failure event occurs from End-Cell to Internal-Cells. The appearance of this type of failure event is that of a collapsing accordion.

There have been attempts to solve this problem. Manufacturers of V-Cell air filters have addressed the collapse problem from a frame design perspective and by modifying the filter frame itself. The manufacturers have modified the frames by adding permanent supports to the bottom of end-cells and/or top of adjacent cells. There are several drawbacks to permanently modifying the frame itself. One such drawback is to the quality of the product without adequately supporting the V-Cell frame. Augmenting V-Cell filter frames with permanently adhered small supports cannot adequately redistribute forces applied to a V-Cell filter frame. Additionally, the permanently adhered support structure will also limit airflow. The greater the permanent support provided the lower the airflow a filter can achieve. Another drawback is from a cost perspective. Augmenting the frame with supports increases frame complexity which increases the likelihood of defective units failing the quality control process. And failures mean higher costs because of increased discard rates. An additional drawback with augmenting the filter frame with small supports limits production scalability as the time spent during the frame construction process increases as frame complexity increases. Thus, modifying the filter frame is a labor intensive, high-cost, inefficient, and ultimately ineffective approach to the prevention of V-Cell air filter frame collapse.

Accordingly, there is still an unsolved need that addresses the problem of air filter frame collapse during shipping that does not involve permanently modifying the air filter and may address other existing issues.

### SUMMARY

The disclosed device is unique when compared with other known devices and solutions because it provides a structurally different device as an external companion support structure. The disclosed device is unique because it lowers manufacturing complexity, lowers manufacturing costs, increases manufacturing scalability, reduces time to market, redistributes force efficiently, and allows unrestricted operational airflow.

One or more non-limiting embodiments are described of an external support structure for air filter frames that have an inherently weak frame compared to the filtration media contained within cells of the air filter. In one such example, a non-limiting embodiment of the support structure is described that is a version of a support structure that may be used with V-Cell air filter frames which have V-shaped cells.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a pictorial illustration of a V-Cell air filter frame in accordance with an example of an air filter frame highly susceptible to damage during shipping.

FIG. 2 is pictorial image of a bottom view of the V-Cell air filter frame From FIG. 1 in accordance with an example of an air filter frame highly susceptible to damage during shipping.

FIG. 3 is a pictorial illustration of a perspective view of an external support structure in accordance with an illustrative embodiment.

FIG. 4 is a pictorial illustration of a bottom perspective view of a first cover of the external support structure in accordance with an illustrative embodiment.

FIG. 5 is a pictorial illustration of a side view of the first cover of the external support cover in accordance with an illustrative embodiment.

FIG. 6 is a pictorial illustration of a side perspective view of a second cover of the external support structure in accordance with an illustrative embodiment.

FIG. 7 is a pictorial illustration of a side view of the second cover of the external support cover in accordance with an illustrative embodiment.

FIG. 8 is a pictorial illustration of an environmental view demonstrating the external support structure covering a V-Cell air filter frame in accordance with an illustrative embodiment.

### DETAILED DESCRIPTION

In the Summary above, in this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limits include both numbers. For example, “25 to 100” means a range whose lower limit is 25 and upper limit is 100 and includes both 25 and 100.

Referring now to the drawings and the following written description of the present invention, it will be readily understood by those persons skilled in the art that the present invention is susceptible to broad utility and application. Many embodiments and adaptations of the present invention other than those described herein, as well as many variations, modifications, and equivalent arrangements will be apparent from or reasonably suggested by the present invention and the detailed description thereof without departing from the substance or scope of the present invention. This disclosure is only illustrative and exemplary of the present invention and is made merely for purposes of providing a full and enabling disclosure of the invention.

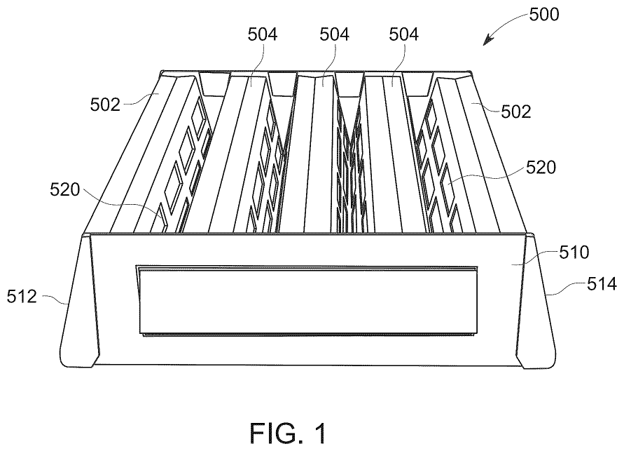

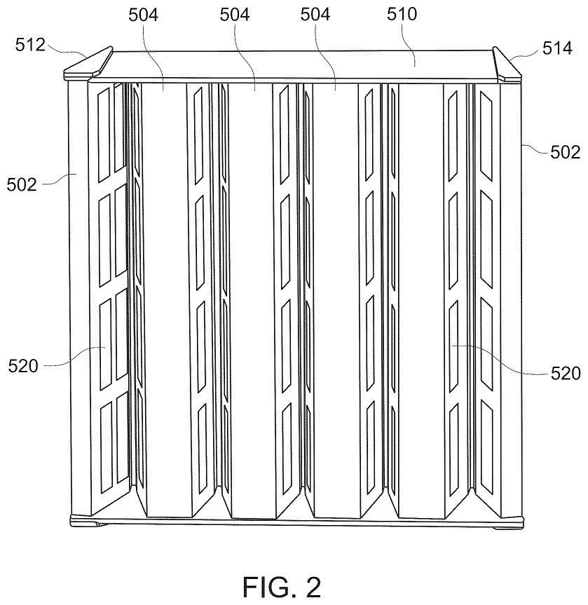

The present disclosure is generally directed to one or more non-limiting embodiments of an external support structure for air filter frames that have an inherently weak frame compared to the filtration media contained within cells of the air filter. One such example of a weak frame compared with media within the cells, is a V-cell air filter 500 (see, FIGS. 1 and 2) described above in the “Background” section. The example of the V-Cell air filter 500 will be used to describe the parts that can make up the invention described herein which complement the shape of the V-Cell air filter frame to provide an external support structure that supports a frame of the air filter to prevent damage to the frame. It is to be understood that other such products, such as other air filter frames with the same problems as described above, can be used to design a support structure as described herein complementing the air filter frame design. It is also to be understood that the external support structure can also be designed for other non-air filter structures having a weak frame that need a support structure for packaging and shipping. Further details are provided below with reference to the figures.

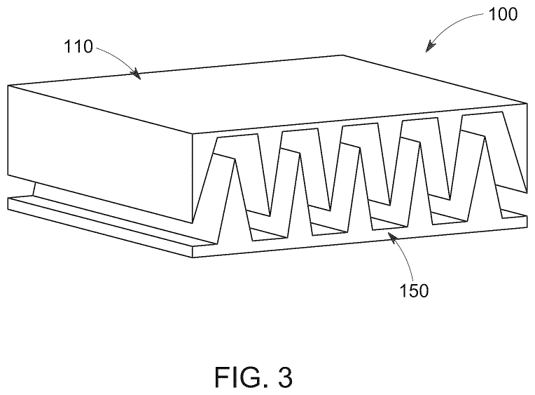

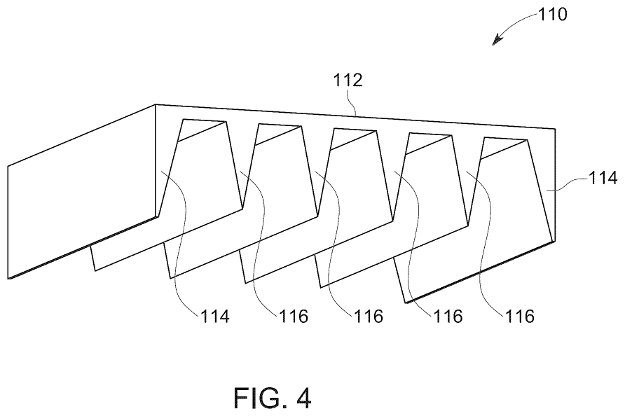

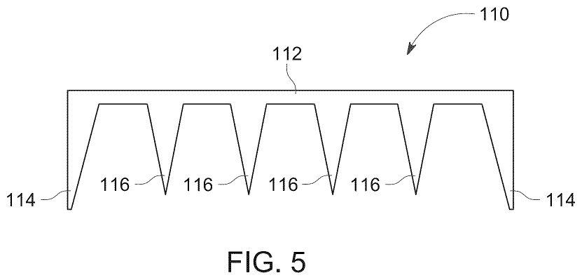

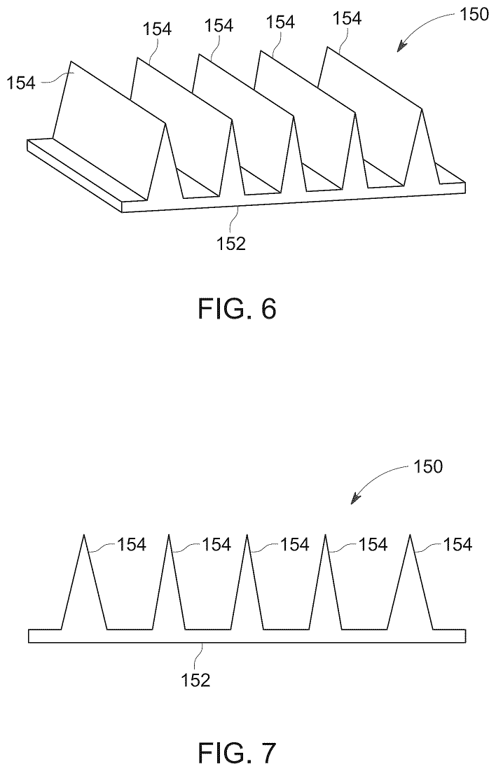

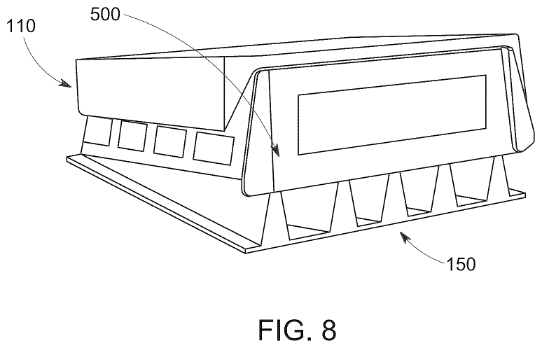

FIGS. 3-8 are illustrations of a non-limiting embodiment of a support structure 100, which is an example of a device that can be used to distribute applied force to an air filter frame. The support structure 100 is an external structure that is removable and is not manufactured into the filter frames. The non-limiting embodiment of the support structure 100 is a version of a support structure that may be used with V-Cell air filter frames 500 which has V-shaped cells, including end cells 502 and internal cells 504. The V-Cell air filter frame 500 includes a frame 510 which forms the outer structure of the air filter frame 500 and a media pack 520 compacted within the frame 510. As seen in the figures, the frame 510 of V-Cell filter frame 500 is sloped at a left edge 512 and a right edge 514 (“left” and “right” are relative to the view of the figure). A top of the V-Cell air filter frame 500 is defined by a narrower end of the frame 510 and a bottom of the V-Cell air filter frame 500 is defined by a wider end of the frame 510. As described above in the “Background” section, the V-Cell air filter frames have a high collapse rate at pivot points which are at the top of each end cell 502 and top of each internal cell 504.

Referring to FIGS. 3 to 8 for a description of the support structure 100 in relation to the V-Cell air filter frame 500 in FIG. 1, the support structure 100 is designed to distribute any applied force(s) on the V-Cell air filter frames 500. The support structure 100 is designed to be placed around the frame 510 of the V-Cell air filter frame 500 (see, FIG. 8) and is configured such as to move the collapsing force(s) away from the pivot points on the tops of the end cells 502 and the tops of the internal cells 504. The support structure 100 redistributes the applied force(s) across an entire face of each of the end cells 502 and each of the internal cells 504. This lowers the applied force(s) applied to any individual portion of the V-Cell frame 510 such that no points on the cells 502, 504 experience significantly greater force than other points on the frame 510.

As seen in FIG. 3, the support structure 100 comprises of a top cover 110 and a bottom cover 150. The top cover 110 is configured to be positioned over the top of the V-Cell air filter frame 500 and the bottom cover 150 is configured to be positioned over the bottom of the V-Cell air filter frame 500 (see, FIG. 8 for the environmental view). In this non-limiting embodiment, the support structure 100 is designed to cover the following surfaces of the V-Cell air filter frame 500: the top (the narrower end of frame 510), the bottom (the wider end of the frame 510), and the sloped left and right edges 512, 514, respectively. With this configuration of the support structure 100, the applied force is applied evenly across the air filter frame 510, which will be described and explained below with the configuration of the support structure 100. It is to be understood that the support structure 100 may alternatively have a fully encompassing structure wherein an entire structure of the V-Cell air filter frame 500 is covered by the support structure.

Referring to FIGS. 3 to 7, the top cover 110 comprises a base component 112, a first and second end redistribution components 114, and internal redistribution components 116. The top cover 110 is a single structure comprising the above components. The top cover 110 configuration distributes an applied force(s) delivered to the top of the air filter frame 500 and delivered to the end cells 502. The base component 112 of the top cover 110 is a flat structure configured to cover a top end of the V-Cell air filter frame 500. The base component has a thickness that prevents damage to the V-Cell air filter frame 500 from an applied force(s). The base component 112 prevents the V-Cell frame 510 from direct contact with any downward external forces by being positioned above the tops of the end cells 502 and the tops of the internal cells 504. The base component 112 also prevents the V-Cell frame 510 from direct contact with lateral external forces by extending beyond the end cells 502 or the narrow end of the frame 510 along both the left and right edge 512, 514. The lateral forces are directed away from the tops of the end cells 502 and are distributed across the tops of the end and internal cells 502, 504 preventing any damage to the end and internal cells 502, 504.

The first and second end redistribution components 114 of the top cover 110 are configured on two opposite ends of the base component 112. The end redistribution components 114 are positioned such that when the top cover 110 is placed on the frame 510, the end redistribution components 114 project downward along the left and right edge 512, 514 of the V-Cell frame 510. An internal facing side of the end redistribution components 114 is configured to abut against the sloped left and right edges 512, 514 and an outside facing surface of the end redistribution components 114 is flat and generally perpendicular to the base component 112. The end redistribution components 114 move a focal point of the applied force from the end cell 502, and specifically a portion of the end cell at the narrow end of the frame 510, to the entire face of the end cell 502. This prevents a collapse of the top ends of the end cells 502 and the internal cells 504 caused by forces exerted at a top of the V-Cell Frame 510.

Additionally, the internal redistribution components 116 are also configured on the base component 112 and are relatively parallel to the end redistribution components 114. The internal redistribution components 116 are configured to fit snugly in the spaces between adjacent end cells 502 and the internal cells 504 and spaces between adjacent internal cells 504. These internal redistribution components 116 are configured with a shape that complements the spaces between adjacent end cells 502 and internal cells 504 and the spaces between adjacent internal cells 504. Because the internal redistribution components 116 are wider at the connection with the base component 112, when the top cover 110 is placed over the top end of the V-Cell air filter frame 500, the forces applied at near the tops of the end cells 502 and internal cells 504 are evenly redistributed to the entire faces near the tops of the end cells 502 and the internal cells 504. This prevents the top ends of the cells 502, 504 from collapse caused by forces exerted atop of the V-Cell air filter frame 500.

The bottom cover 150 of the support structure 100 comprises a base component 152 and internal redistribution components 154. The bottom cover 150 is also a single structure comprising the above components. Like the top cover 110, the bottom cover 150 also has a configuration that redistributes an applied force(s) delivered to the bottom of the air filter frame 500 and to the end cells 502. The base component 152 of the bottom cover 150 is a flat structure configured to cover a bottom end of the V-Cell air filter frame 500 and sized equally to the top cover 110. The base component 152 has a thickness that allows an applied force(s) to prevent damage to the V-Cell air filter frame 500. The base component 152 prevents the V-Cell frame 510 from direct contact with any upward external forces by being positioned at the bottom end of the V-Cell air filter frame 500, which is essentially against the bottom ends of the end cells 502 and the internal cells 504. The base component 152 also prevents the V-Cell frame 510 from direct contact with lateral external force by extending beyond the left edge 512 and the right edge 514 of the V-Cell air filter frame 500. Lateral forces are directed away from the end cell 502 of the V-Cell air filter frame 500 and are redistributed across a bottom surface of the end cells 502 which prevents the end cells 502 from sheering off.

The internal redistribution components 154 of the bottom cover 150 are configured similarly to the internal redistribution components 116 of the top cover 110. Thus, the internal redistribution components 154 of the bottom cover 150 are configured to snugly fit in the spaces between adjacent end cells 502 and the internal cells 504, and spaces between adjacent internal cells 504. These internal redistribution components 154 are configured with a shape that complements the spaces between adjacent end cells 502 and internal cells 504, and the spaces between adjacent internal cells 504. Because the internal redistribution components 154 are wider at the connection with the base component 152, when the bottom cover 150 is placed over the bottom end of the V-Cell air filter frame 500, the forces applied to the end cells 502 and internal cells 504 near the bottom cover 150 are evenly redistributed to the entire faces of the end cells 502 and the internal cells 504.

It is to be understood that the materials used will be common materials known or to be known in the future that can be used as packaging material and that can also help redistribute the applied forces. Other iterations of the design are within the disclosure of the invention as long as the structure is an external structure and not configured into the air filter itself and further the functional purpose is to redistribute applied force and prevent collapse of the frame and/or the cells.

Accordingly, the present description provides for various embodiments for the support structure 100 that can be used to package and ship the V-Cell air filter frames 500. The support structure addresses the collapse problem that the frame may experience from an applied force to the top, bottom, or sides of an air filter frame. Many uses and advantages are offered by the device 100 as described above in one or more non-limiting embodiments in the present description.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A structure comprising:
an external support structure for air filters used during packaging and delivery, comprising:
a top cover having a base component, a first and second end redistribution components, and one or more internal redistribution components;
a bottom cover having a base component and one or more internal redistribution components; and
wherein the top and bottom covers are positioned around an air filter frame, so as to redistribute external forces applied to a top, a bottom, a left side, or a right side of the air filter frame.

2. The structure of claim 1, wherein the base component on each of the top and bottom covers is a flat structure.

3. The structure of claim 1, wherein the base component of the top cover is configured to extend beyond a left and right ends of an air filter, wherein the first and second end redistribution components are configured on the base component of the top cover to extend along and abut against the left and right ends of the air filter.

4. The structure of claim 3, wherein the first and second end redistribution components complement a shape of the left and right ends of the air filter such that the first and second end redistribution components snugly fit against an entire length of the left and right ends of the air filter.

5. The structure of claim 3, wherein the first and second end redistribution components are wider at a connection with the base component of the top cover.

6. The structure of claim 1, wherein the one or more internal redistribution components of the top cover are configured on the base component of the top cover, wherein the one or more internal redistribution components of the top cover project away from the base component of the top cover and have a shape that complements a shape of one or more open spaces between internal cells of the air filter, wherein the one or more internal redistribution components of the top cover fit snugly between the one or more open spaces of the internal cells of the air filter.

7. The structure of claim 6, wherein the one or more internal redistribution components of the top cover are wider at a connection with the base component of the top cover.

8. The structure of claim 1, wherein the base component of the bottom cover is configured to extend beyond a left and right ends of an air filter, wherein the base component of the bottom cover has a length and a width that is equal to a length and a width of the top cover.

9. The structure of claim 1, wherein the one or more internal redistribution components of the bottom cover are configured on the base component of the bottom cover, wherein the internal redistribution components of the bottom cover project away from the base component of the bottom cover and have a shape that complements a shape of one or more open spaces between internal cells of an air filter, wherein the one or more internal redistribution components of the bottom cover fit snugly between the one or more open spaces of the internal cells of the air filter.

10. The structure of claim 9, wherein the one or more internal redistribution components of the bottom cover are wider at a connection with the base component of the bottom cover.

11. A structure comprising:
an external support structure for air filters used during packaging and delivery, comprising:
a top cover having a base component, a first and second end redistribution components, and one or more internal redistribution components;
a bottom cover having a base component and one or more internal redistribution components; and
wherein the top and bottom covers are positioned around an air filter frame to cover a top, a bottom, a left side, and a right side of an air filter, so as to redistribute external forces applied to the top, the bottom, the left side, and the right side of the air filter frame, wherein applied external forces are applied evenly across the air filter frame.

12. The structure of claim 11, wherein the base component on each of the top and bottom covers is a flat structure.

13. The structure of claim 11, wherein the base component of the top cover is configured to extend beyond a left and right ends of the air filter, wherein the first and second end redistribution components are configured on the base component of the top cover to extend along and abut against the left and right ends of the air filter.

14. The structure of claim 13, wherein the first and second end redistribution components complement a shape of the left and right ends of the air filter such that the first and second end redistribution components snugly fit against an entire length of the left and right ends of the air filter.

15. The structure of claim 13, wherein the first and second end redistribution components are wider at a connection with the base component of the top cover.

16. The structure of claim 11, wherein the one or more internal redistribution components of the top cover are configured on the base component of the top cover, wherein the one or more internal redistribution components of the top cover project away from the base component of the top cover and have a shape that complements a shape of one or more open spaces between internal cells of the air filter, wherein the one or more internal redistribution components fit snugly between the one or more open spaces of the internal cells of the air filter.

17. The structure of claim 16, wherein the one or more internal redistribution components are wider at a connection with the base component of the top cover.

18. The structure of claim 11, wherein the base component of the bottom cover is configured to extend beyond a left and right ends of the air filter, wherein the base component of the bottom cover has a length and a width that is equal to a length and a width of the top cover.

19. The structure of claim 11, wherein the one or more internal redistribution components of the bottom cover are configured on the base component of the bottom cover, wherein the one or more internal redistribution components project away from the base component of the bottom cover and have a shape that complements a shape of one or more open spaces between internal cells of the air filter, wherein the one or more internal redistribution components of the bottom cover fit snugly between the one or more open spaces of the internal cells of the air filter.

20. The structure of claim 19, wherein the one or more internal redistribution components of the bottom cover are wider at a connection with the base component of the bottom cover.
